(19) United States
(12) Patent Application Publication
(10) Pub. No.: US 2020/0232274 A1
(43) Pub. Date: Jul. 23, 2020

(54) Screen Installation Improvements

(71) Applicant: FlexScreen LLC, Murrysville, PA (US)

(72) Inventor: Joseph A. Altieri, JR., Pittsburgh, PA (US)

(21) Appl. No.: 16/250,930

(22) Filed: Jan. 17, 2019

(51) Int. Cl. E06B 9/52

(52) U.S. Cl. CPC E06B 9/521; E06B 2009/527

(57) ABSTRACT

Disclosed are gaskets and methods for assisting with the installation and retainer of screens into window or door frames. The gasket is made with a deformable and resilient material such as a dense elastomer and is attached to a distal surface of the screens using adhesive tape or glue. When the screen is installed, the gasket deforms and creates an enlarged surface area of gasket material that uses frictional force to keep the screen in place.

### CROSS-REFERENCE TO RELATED APPLICATIONS

N/A

### BACKGROUND OF THE INVENTION

The invention relates generally to removable window and door screens and more specifically to embodiments of replacement and retrofit screens.

One type of screen that is in common use in modern residential and commercial construction is the type that is held in place in a door or window opening by way of parallel sides of its frame fitting within receiving channels running along one or more parallel sides of the door or window opening. In some cases, these receiving channels are located on the vertical sides of the window or door opening, while in others they are located on the top and bottom horizontal sides of the opening. Typically, at least one of the receiving channels is u-shaped in the sense that it has two walls and a base, while another of the receiving channels may be either a full u-shaped channel or only a partial channel wherein it has either just one retaining wall side or two retaining wall sides of unequal height.

When an original screen that came with a window wears out or is damaged, a replacement screen from the manufacturer can be used, if they are still manufacturing a screen for the window. Alternatively, the original screen may have its mesh replaced, but often, the wood in the window frame has warped or the channels have been damaged or painted over or the screen frame has been bent such that the new or repaired screen does not stay in position on the window or door properly.

One type of replacement screen is set forth in U.S. Pat. No. 9,234,388 to Alfieri (the '388 patent), the entire contents of which is hereby incorporated as if more fully set forth herein. The '388 patent teaches a screen comprised of a screen frame and a screen mesh. When assembled as a complete apparatus, the screen mesh and the screen frame form a preselected shape. The frame is comprised of a flexible spring-like material, such as spring steel wire, for at least one of its sides, but does not put any pressure on the window frame for installation. As a result, the replacement screen also typically needs a channel in order to remain in place over the window.

Some window and door openings, however, don't have any channels at all because they were the type of window or door that does not typically have a screen. Another common situation is where a screen holding attachment that was originally installed onto the window frame has been removed or damaged. This situation presents a challenge for the after-market manufacturer of replacement screens because there is no existing infrastructure for holding the screen in place. What is needed is a screen that can be held in place by the existing perimeter even when there aren't any channels.

### SUMMARY OF THE INVENTION

The present invention discloses an installation assistance gasket for an OEM or replacement window or door screen. In embodiments, the installation assistance gasket is installed on a distal surface of the screen leg members so that it contacts the window or door frame. Upon contact, the gasket deforms and creates an area of increased friction that holds the screen in place in situations where there is no other screen retention mechanism such as a channel.

In embodiments, the gasket is formed from a material that is resilient and deformable such as a dense elastomer and optionally has a hollow center to assist with deformation, although a hollow center may not be required for certain materials.

The installation assistance gasket may be attached to the screen at the time of manufacturing or it may be applied by the user. Application is typically performed through the use of adhesive tape, on a distal edge of the screen, to which the gasket is applied. Other attachment methods are also possible, such as welding, adhesion or mechanical fastening.

In further embodiments, a kit will be provided containing one or a plurality of lengths of gasket material for sizing and application by the end user.

### BRIEF DESCRIPTION OF THE DRAWINGS

The features and merits of the present invention will be better understood by reference to the attached drawings. It is to be understood, however, that the drawings are designed for the purpose of illustration only and not as definitions of the limits of the present invention.

FIG. 1 is an elevational view of a window or door screen having perimeter gaskets constructed according to an embodiment of the present invention.

FIG. 2 is an isometric view of a portion of a screen, as depicted in FIG. 1, having a perimeter gasket disposed thereon.

FIG. 3 is an elevational view of a portion of a screen having perimeter gasket consistent with the embodiment depicted in FIG. 1 installed in a window frame.

FIG. 4 is an elevational view of a window or door screen having a perimeter gasket constructed in accordance with an embodiment of the present invention.

### DETAILED DESCRIPTION OF THE INVENTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

Whenever the term “about” is used herein or in the appended claims to modify a feature of an embodiment of the present invention, it is to be construed as referring to the ordinary tolerances related to making and/or measuring the relevant feature. Whenever a range is used herein or in the appended claims to describe a feature of an embodiment of the present invention, the range is to be construed as including the stated or implied end points of the range and every point therebetween.

The present invention provides an improved installation assistance attachment for both original and replacement screens for windows and doors. Where existing window or door perimeter infrastructure comprises a channel, the attachment of the present invention can serve to enable the screen to fit more snugly and to assure a secure fit. Further, where the existing window or door perimeter infrastructure does not have a channel or other retaining device, the disclosed attachment can hold the screen in the desired location by increasing the friction between the screen and the window or door frame.

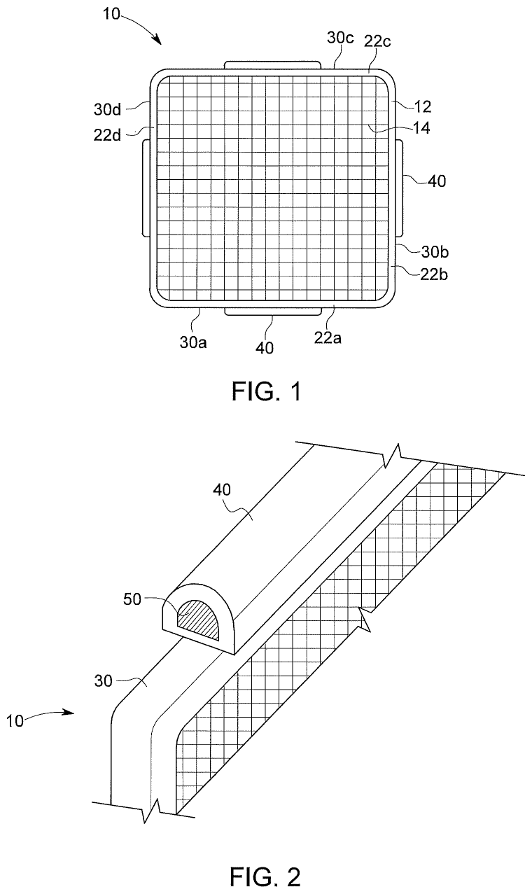

FIGS. 1-3 illustrate a front elevational view of a screen 10 having a frame 12 and screen mesh 14. While there are many different screen shapes, the screen 10 illustrated in FIGS. 1 and 2 has a substantially square frame 12 having a plurality of leg members 22a, b, c and d each having a distal surface 30a-d. In the illustrated embodiment, each leg member has a perimeter gasket 40 disposed on the distal surface.

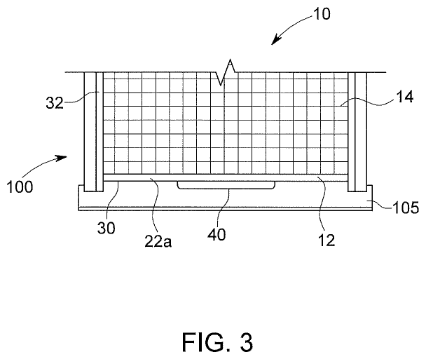

Other embodiments may require the application of a gasket 40 to less than all four leg members. FIG. 3, for example, illustrates a window or door frame 100 having a channel 32 on each vertical side of the screen 10, but no channel along the horizontal bottom leg member 22a. To ensure the screen fits properly and stays in place, a perimeter gasket 40 is disposed on the bottom leg member 22a. Due to the weight of the screen 10, the gasket 40 is pressed against the window sill 105. In certain embodiments, when the gasket 40 is pressed against a surface, it flattens out and the surface area of the gasket that comes in contact with the window sill 105 increases, which maximizes the friction afforded by the gasket 40 and helps keep the screen 10 in place.

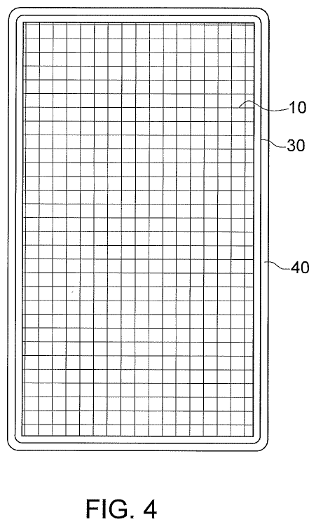

In certain embodiments, each gasket 40 extends less than half the length of the leg member 22 a-d and is substantially centered thereon. Other embodiments may cover more or less of the distal surface 30 a-d depending on the situation. In one non-limiting example, the screen 10 may be large and heavy, in which case, more friction will be desired between the perimeter gasket 40 and the existing window or door frame 100 if no channel 32 is present. In such a case, a greater amount of perimeter gasket 40 can be applied to the distal surface of the leg member that presses against the window frame and bears the weight of the screen. In embodiments, the perimeter gasket 40 covers the entire distal surface 30 of the leg member 22. Due to the structure and material properties chosen for certain embodiments of perimeter gaskets 40, the greater the amount of gasket in contact with the window frame 100, the greater the friction and thus the greater the retaining power of the gasket. In another non-limiting example illustrated by FIG. 4, the gasket 40 can be applied to the entire perimeter to enhance hold in a window frame.

FIG. 2 illustrates an elevational perspective view of a portion of a screen 10 having an embodiment of a gasket 40 disposed on a distal surface 30 of a screen frame 10. In certain embodiments, the gasket 40 is “D-shaped” and has a hollowed out central void 50 for ease of deformation. In other embodiments, the gasket 40 is not “D-shaped” or does not contain a central void 50 but still deforms easily due to the selection of a suitable material. In embodiments, the gasket 40 is disposed on the distal surface 30 using double-faced tape, glue, pressure sensitive adhesive, or other adhesive method. In an embodiment, the gasket 40 is attached to the distal surface 30 using an acrylic-based, double-sided adhesive transfer tape. In still another embodiment, the gasket 40 is mechanically attached to one or more leg members 22 of the screen 10.

Certain embodiments of the gasket 40 are designed to collapse under less pressure than is required to bend the leg members 22a-d, such as when a screen 10 constructed in accordance with the '388 patent has leg members 22 that bend to permit the screen 10 to be installed or removed from the window or door frame 100. As a result, the gasket 20 collapses when the screen is installed and increases the surface area and resulting friction that is applied to the opening perimeter to keep the screen 10 in place, such as when there is no channel.

In certain embodiments, gaskets 40 of the present invention are constructed of a lightweight, compressible material. The material may further be substantially deformed but will return to its original shape when pressure is removed. Suitable materials include dense elastomers, including: natural rubber, SBR (styrene butadiene), EPDM (Ethylene Propylene Diene Monomer), Neoprene, Nitrile, Silicone, FKM (Fluorinated Hydrocarbon), and TPE (thermoplastic elastomer). Other materials may be used of course, so long as they resiliently compress and create friction with an external surface, such as a window frame, when they are compressed.

In certain embodiments, the gasket 40 is applied during manufacture and delivered to the customer already installed. In these embodiments, the gasket 40 may be applied using an adhesive tape, a glue, welding, or through the use of clips or other mechanical fastening means to the distal surface of the screen.

Other alternative embodiments provide for the delivery of a kit containing a length of gasket material, either standing alone or along with a replacement screen, for the customer to apply as-needed. In this embodiment, the gasket material will have an adhesive tape or film with a backing that can be peeled off the gasket so that it will stick to the distal surface. In some embodiments, the gasket material will be provided as a single length so that the appropriate length can be chosen by the user, such as by cutting the gasket at the appropriate length with a pair of scissors. In other embodiments, multiple lengths of gasket material can be provided in standardized lengths such as twelve inches or eighteen inches.

While only a few embodiments of the present invention have been shown and described, it will be apparent to those skilled in the art that many changes and modifications may be made to the disclosed apparatuses and methods without departing from the spirit and scope of the present invention. All patent applications, patents, and all other publications referenced herein are incorporated herein in their entireties to the full extent permitted by law.

What is claimed is:

1. An installation assistance gasket for a window or door screen having a plurality of leg members, each leg member having an outer edge surface, the installation assistance gasket comprising:
a length of deformable material disposed on the outer edge surface of at least one leg member.

2. The installation assistance gasket set forth in claim 1, wherein the deformable material is resilient.

3. The installation assistance gasket set forth in claim 1, wherein the deformable material is a dense elastomer.

4. The installation assistance gasket set forth in claim 1, wherein the deformable material is selected from the group consisting of natural rubber, SBR, EPDM, Neoprene, Nitrile, Silicone, FKM, and TPE.

5. The installation assistance gasket set forth in claim 1, wherein the deformable material has a hollow center.

6. The installation assistance gasket set forth in claim 1, wherein the deformable material has a high coefficient of friction when it is deformed.

7. The installation assistance gasket set forth in claim 1, wherein the length of deformable material is secured to the screen frame by melting, welding, adhesion or mechanical fastening.

8. A method of preparing a screen to facilitate installation of the screen into a window or door frame having no mechanical retaining means, the screen having a plurality of distal surfaces for engaging the window or door frame with a first friction, the method comprising:
fixably applying a gasket to a one or more distal surfaces of the screen, the gasket comprised of a resilient, deformable material, whereby a second friction between the surfaces is created.

9. The method of claim 8, further comprising cutting the gasket to a desired length.

10. The method of claim 8, wherein the second friction is greater than the first friction.

11. A kit for modifying a replacement screen having one or more leg members to be used with a window or door frame lacking securement channels comprising:
one or more lengths of gasket material, the gasket material having a flat surface;
an adhesive to be applied to the flat surface to enable attachment to one or more leg members.
